(19) United States
(12) Patent Application Publication
(10) Pub. No.: US 2004/0022349 A1
(43) Pub. Date: Feb. 5, 2004

(54) Medical image capturing system, server apparatus and method of controlling medical image capturing system

(76) Inventor: Akira Hagiwara, Tokyo (JP)

Correspondence Address: Patrick W. Rasche, Armstrong Teasdale LLP, Suite 2600, One Metropolitan Square, St. Louis, MO, 63102, US

(21) Appl. No.: 10/627,216

(22) Filed: Jul. 25, 2003

(30) Foreign Application Priority Data
Jul. 26, 2002 (JP) 2002-218473

(51) Int. Cl. H05G 1/00

(52) U.S. Cl. 378/4; 705/3; 709/200

(57) ABSTRACT

For the purpose of simplifying software management, an operation console reads projection data at Step S401, generates transmitted data at Step S402, and transmits the data to a server at Step S403. The server receives the transmitted data at Step S451, and executes error correction processing on raw data at step S452. Next, at Step S453, image reconstruction processing is executed based on the raw data corrected at Step S452 to produce an X-ray tomographic image. At Step S454, the data of the X-ray tomographic data is transmitted to the operation console. The operation console then receives the data of the X-ray tomographic image at Step S404, and saves the received data of the X-ray tomographic image or displays it as an image at Step S405.

### BACKGROUND OF THE INVENTION

The present invention relates to a medical image capturing system, such as an X-ray CT system, for collecting imaging data of a subject and providing a medical image based on the data.

An X-ray CT system is generally comprised of a gantry apparatus and an operation console. The gantry apparatus generally has functions of illuminating a subject with X-rays, detecting X-rays transmitted through the subject, and collecting projection data of the subject. The operation console has functions of setting in detail a scan (scan scheme) to be conducted by the gantry apparatus, transmitting the scan scheme to the gantry apparatus, executing image reconstruction processing based on the projection data transmitted from the gantry apparatus, and producing a tomographic image of the subject. Therefore, the operation console has application software for setting the scan scheme, transmitting the scan scheme, executing image reconstruction processing, and the like.

In general, application software is frequently upgraded for improvement of functions and correction of errors. To use the latest versions of application software, it is necessary to install them in the operation console.

Recently, it has become possible for the operation console to be supplied with application software from a server by a configuration such that the server and the client operation console are connected with each other via a network such as the Internet or a LAN. By this configuration, the operation console can be supplied with the latest versions of application software from the server so long as the latest versions of application software are always kept in the server.

However, when a plurality of X-ray CT systems are installed in a hospital, for example, it is still necessary to download the latest versions of application software and install them in the operation consoles of the X-ray CT systems even if the aforementioned network technology is employed, which leads to a problem of significantly troublesome operations.

### SUMMARY OF THE INVENTION

Therefore, an object of the present invention is to provide a medical image capturing system in which software management is simplified.

To attain the object of the present invention, a medical image capturing system in accordance with the present invention has, for example, the following configuration.

Specifically, the medical image capturing system comprising a gantry apparatus for collecting imaging data of a subject, an operation console for sending an operation command to said-gantry apparatus, and at least one server apparatus communicably connected to said operation console via a network, is characterized in that: said operation console comprises: receiving means for receiving the collected imaging data from said gantry apparatus; and transmitting means for transmitting said received imaging data to said server apparatus; and said server apparatus comprises: image producing means for producing a medical image based on said imaging data transmitted from said operation console; and transmitting means for transmitting said produced medical image to said operation console.

Preferably, the medical image capturing system is characterized in that: each said server apparatus comprises separate image producing means for producing a medical image by a different algorithm based on said imaging data transferred from said operation console; and said operation console further comprises selecting means for selecting a server apparatus to which said imaging data received by said receiving means is to be transferred.

Preferably, the medical image capturing system is characterized in that: said server apparatus further comprises conveying means for conveying billing information concerning use of said image producing means to said operation console.

Preferably, the medical image capturing system is characterized in that said server apparatus further comprises conveying means for conveying a medical image attached with an image representing the billing information concerning use of said image producing means to said operation console.

To attain the object of the present invention, a server apparatus in accordance with the present invention has, for example, the following configuration.

Specifically, the server apparatus communicably connected via a network to an operation console for sending an operation command to a gantry apparatus for collecting imaging data of a subject, is characterized in comprising: image producing means for producing a medical image based on said imaging data transmitted from said operation console; and transmitting means for transmitting said produced medical image to said operation console.

Preferably, the server apparatus is characterized in further comprising: conveying means for conveying billing information concerning use of said image producing means to said operation console.

Preferably, the server apparatus is characterized in further comprising: conveying means for conveying a medical image attached with an image representing the billing information concerning use of said image producing means to said operation console.

To attain the object of the present invention, a method of controlling a medical image capturing system in accordance with the present invention has, for example, the following configuration.

Specifically, the method of controlling a medical image capturing system comprising a gantry apparatus for collecting imaging data of a subject, an operation console for sending an operation command to said gantry apparatus, and at least one server apparatus communicably connected to said operation console via a network, is characterized in comprising: a method of controlling said operation console comprising: a receiving step of receiving the collected imaging data from said gantry apparatus; and a transmitting step of transmitting said received imaging data to said server apparatus; and a method of controlling said server apparatus comprising: an image producing step of producing a medical image based on said imaging data transmitted from said operation console; and a transmitting step of transmitting said produced medical image to said operation console.

Preferably, the method of controlling a medical image capturing system is characterized in that: said method of controlling each said server apparatus comprises a separate image producing step of producing a medical image by a different algorithm based on said imaging data transferred from said operation console; and said method of controlling said operation console further comprises a selecting step of selecting a server apparatus to which said imaging data received at said receiving step is to be transferred.

Preferably, the method of controlling a medical image capturing system is characterized in that: said method of controlling said server apparatus further comprises a conveying step of conveying billing information concerning use of said image producing step to said operation console.

Preferably, the method of controlling a medical image capturing system is characterized in that: said server apparatus further comprises a conveying means for conveying a medical image attached with an image representing the billing information concerning use of said image producing means to said operation console.

To attain the object of the present invention, a method of controlling a server apparatus in accordance with the present invention has, for example, the following configuration.

Specifically, the method of controlling a server apparatus communicably connected via a network to an operation console for sending an operation command to a gantry apparatus for collecting imaging data of a subject, is characterized in comprising: an image producing step of producing a medical image based on said imaging data transmitted from said operation console; and a transmitting step of transmitting said produced medical image to said operation console.

Preferably, the method of controlling a server apparatus further comprises: a conveying step of conveying billing information concerning use of said image producing step to said operation console.

Preferably, the method of controlling a medical image capturing system is characterized in that: said server apparatus further comprises a conveying means for conveying a medical image attached with an image representing the billing information concerning use of said image producing means to said operation console.

Therefore, the present invention can simplify software management.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing a general configuration of an X-ray CT system in accordance with a first embodiment of the present invention.

FIG. 2 is a block diagram showing a basic configuration of an operation console 102 and a server 104.

FIG. 3 is a diagram showing an exemplary configuration of transmitted data in accordance with the first embodiment of the present invention.

FIG. 4 is a flow chart of processing executed by the operation console and server in accordance with the first embodiment of the present invention.

FIG. 5 is a diagram showing a general configuration of a system in accordance with a second embodiment of the present invention.

FIG. 6 is a diagram showing an example of a GUI for selecting a server executing image reconstruction processing.

FIG. 7 is a diagram showing a table in which server information is registered along with IP addresses of the servers.

FIG. 8 is a diagram showing an exemplary configuration of transmitted data in accordance with the second embodiment of the present invention.

FIG. 9 is a diagram showing an example of a window displaying a billing charge.

FIG. 10 is a flow chart of processing executed by the operating console and server in accordance with the second embodiment of the present invention.

### DETAILED DESCRIPTION OF THE INVENTION

The present invention will now be described in detail based on preferred embodiments with reference to the accompanying drawings.

(First Embodiment)

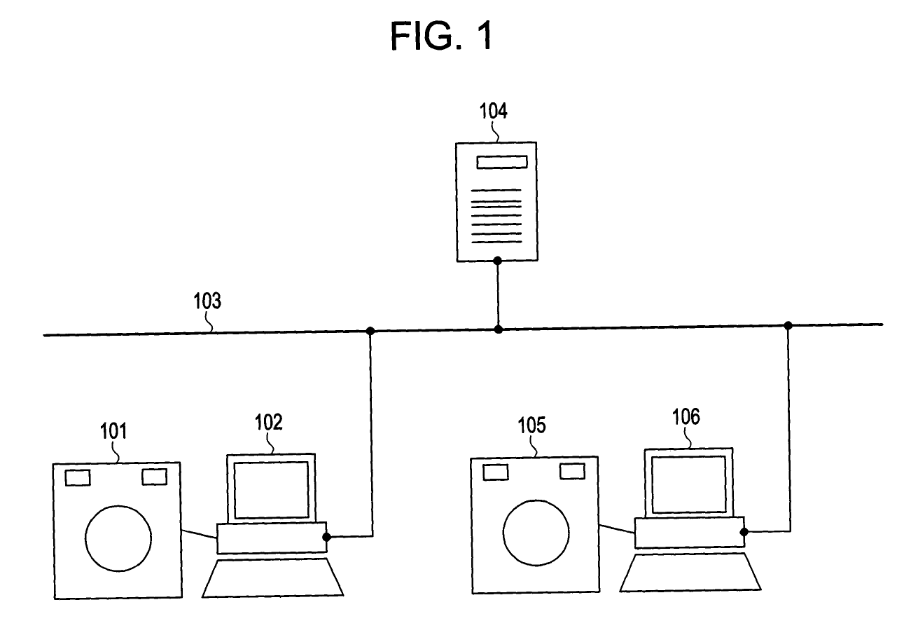

FIG. 1. shows the general configuration of an X-ray CT system in accordance with the present embodiment. Reference numerals 101 and 105 each designate a gantry apparatus, reference numerals 102 and 106 each designate an operation console, reference numeral 103 designates a network employing fiber optics or the like, and reference numeral 104 designates a server (server apparatus). Although two sets of the operation console and gantry apparatus are connected to the network 103 in FIG. 1, the number is not limited to two.

The gantry apparatus 101(105) has functions of illuminating a subject with X-rays according to a scan scheme transmitted from the operation console 102(106), and collecting projection data (imaging data) based on X-rays transmitted through the subject. The projection data is transmitted to the operation console 102(106). The operation console 102(106) transmits the received projection data to the server 104 via the network 103, and the server 104 executes image reconstruction processing using the received projection data to produce an X-ray tomographic image of the subject. The produced X-ray tomographic image is transmitted to the operation console 102(106) again via the network 103, and the operation console 102(106) stores the received X-ray tomographic image in a memory or displays it on a display section.

The following description will be made on the operation console 102 and the server 104 associated with processing for producing an X-ray tomographic image based on projection data obtained from the gantry apparatus 101. The following description similarly applies to processing executed by the operation console 106 and the server 104.

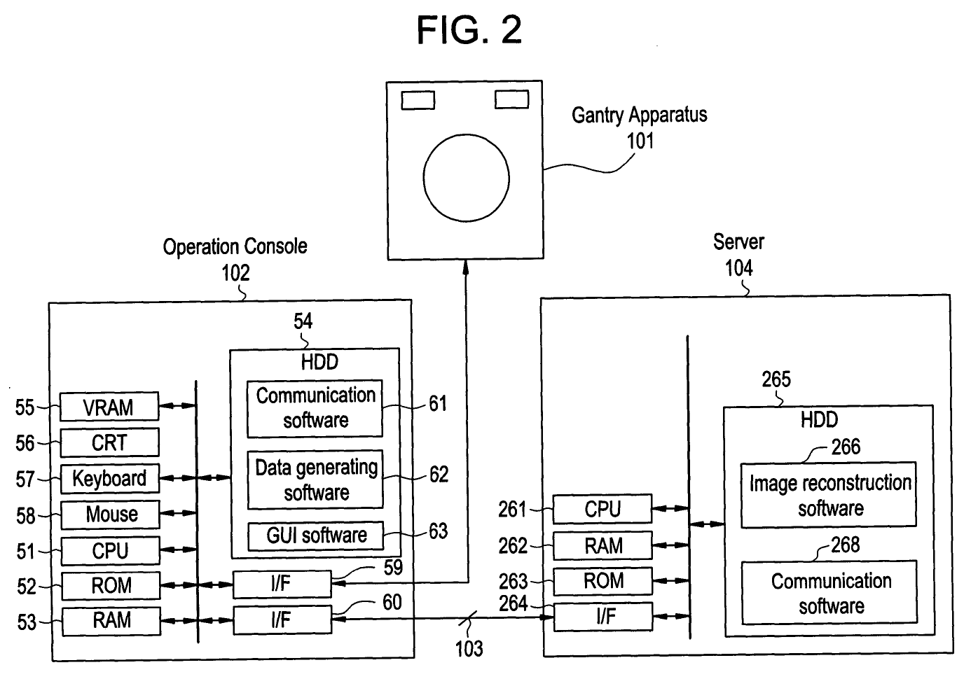

FIG. 2 shows a basic configuration of the operation console 102 and the server 104. In this embodiment, the operation console 102 is capable of transmitting data representing a scan scheme to the gantry apparatus 101 and receiving projection data of the subject obtained by the gantry apparatus 101 via an I/F 59. The operation, console 102 is also capable of accessing the server 104 through the network 103 via an I/F 60, and conducting transmission of transmitted data including the projection data and reception of an X-ray tomographic image of the subject produced by the server 104.

In general, an X-ray tomographic image and projection data have a large amount of data. Therefore, a fast communication network using fiber optics is preferably employed as the network 103.

The operation console 102 is what is generally called a PC (personal computer), comprising a CPU 51 for controlling the entire apparatus, a ROM 52 storing a boot program, a RAM 53 that serves as a main storage device, as shown, and the following components.

HDD 54 is a hard disk device, which stores an OS and application software programs as files, including communication software 61 for communicating with the server 104, data generating software 62 for generating transmitted data including projection data, and GUI software 63, such as a GUI for displaying an X-ray tomographic image, for displaying and controlling several types of GUI's, as well as diagnosis software programs (omitted in the drawing) for supplying several kinds of instructions to the gantry apparatus 101. In addition, the projection data transmitted from the gantry apparatus 101 may be stored on the HDD 54.

A VRAM 55 is a memory for developing image data to be displayed, and the image data can be displayed on a CRT 56 by developing the image data and the like there. Reference numerals 57 and 58 designate a keyboard and a mouse for performing several kinds of settings. Reference numeral 59 designates an interface for communicating with the gantry apparatus 101, and reference numeral 60 designates an interface for communicating with the network 103.

The server 104 comprises a CPU 261 for controlling the entire apparatus, a ROM 262 storing a boot program, a RAM 263 that serves as a main storage device, and the following components.

Reference numeral 264 is an I/F for conducting data communication with the operation console 102. HDD 265 is a hard disk device, which stores an OS and application software programs as files, including image reconstruction software 266 for conducting image reconstruction based on projection data to produce an X-ray tomographic image, and communication software 268 for communicating with the operation console. It should be noted that these application software are always upgraded to the latest versions. This allows the operation console 102(106) that transmits projection data to the server 104 to obtain an X-ray tomographic image produced by these application software kept in the server 104, and therefore, the operation console 102(106) benefits from the latest versions of application software; for example, an X-ray tomographic image can be obtained with higher accuracy.

Moreover, when one desires to use the latest versions of application software on the operation consoles 102 and 106, in the system of the present embodiment, all of a plurality of operation consoles that can be connected to the server 104 (i.e., two consoles in FIG. 1; the operation consoles 102 and 106) benefit from the latest versions of application software by installing the latest versions of application software in the server 104; and thus, benefits of the latest versions of application software can be provided to the plurality of operation consoles by a simpler operation than a conventional operation of downloading the latest versions of application software to every operation console and installing them in every operation console.

Furthermore, according to the present embodiment, if the latest versions of application software are installed only in the server 104, the need for the troublesome work of installing the application software in every X-ray CT system is eliminated. Therefore, management of application software is simplified as compared with the conventional technique.

Next, processing executed by the operation console 102 and server 104 having the aforementioned configuration will be described. The operation console 102 first reads into the RAM 53 projection data of a subject transmitted from the gantry apparatus 101 or that saved in the HDD 54. The projection data has been acquired by the gantry apparatus 101 according to a scan scheme set at the operation console 102. Then, a command to transmit the projection data to the server 104 is input using the keyboard 57 and mouse 58. The input command also contains an identifier of an address (e.g., an IP address) of the destination server on the network 103.

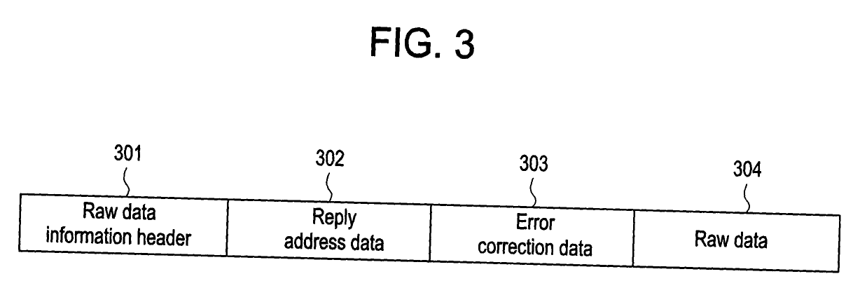

After inputting the command, the data generating software 62 loaded on the RAM 53 is executed by the CPU 51 to generate transmitted data including the projection data. An exemplary configuration of the transmitted data is shown in FIG. 3.

Reference numeral 301 designates a raw data information header that contains information about raw data, such as the size of raw data (projection data) which will be described below, the number of views of the gantry apparatus and the number of channels of a detector for acquiring the raw data, and the date and time of imaging.

Reference numeral 302 designates reply address data that is address data of the operation console 102 on the network, and the server that receives the transmitted data can refer to the data 302 to identify the operation console to which a produced X-ray tomographic image is to be transmitted.

Reference numeral 303 designates error correction data for correcting projection data, and the server 104 uses the error correction data to correct projection data. Reference numeral 304 designates raw data containing one or more units of data, where one unit of data has a data size of (the number of views)×(the number of channels). That is, projection data for one or more slices are contained.

After the CPU 51 has generated such transmitted data by executing the data generating software 62, the communication software 61 loaded on the RAM 53 is executed by the CPU 51 and the transmitted data is transmitted to the server 104.

The transmitted data is accepted in the server 104 and written into the RAM 262 under control of the CPU 261. After the transmitted data have been completely written into the RAM 262, the image reconstruction software 266 loaded on the RAM 262 is executed by the CPU 261 to identify the raw data 304 and error correction data 303 by referring to the raw data information header 301, and correct the raw data 304 using the error correction data 303. Then, the image reconstruction software 266 produces an X-ray tomographic image based on the corrected raw data.

When the X-ray tomographic image is produced, the raw data information header 301 is referred to, and image reconstruction processing is conducted on projection data for each slice, and an X-ray tomographic image is produced for each slice.

After X-ray tomographic images for all the slices have been produced by the image reconstruction software 266, the communication software 268 loaded on the RAM 262 is executed by the CPU 261, and the reply address data 302 is referred to and the X-ray tomographic images are transmitted to an operation console at an identified address (here, the operation console 102). It should be noted that data of an X-ray tomographic image for each slice to be transmitted may be packeted or compressed as necessary.

The operation console 102 writes the data of the X-ray tomographic images received via the network 103 and then the I/F 60 into the RAM 53 by the CPU 51 executing the communication software 61. The data of the X-ray tomographic images written into the RAM 53 may be saved in the HDD 54, or displayed on the CRT 56 by the CPU 51 executing the GUI software 63 loaded on the RAM 53 and writing the X-ray tomographic images into the VRAM 55.

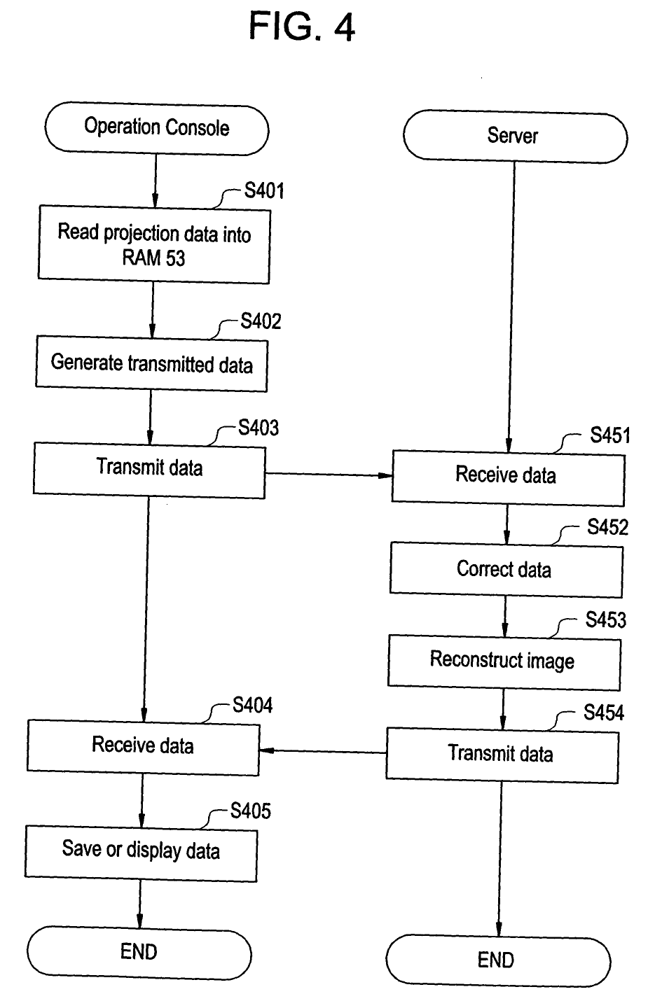

A flow chart of the processing executed by the operation console 102 and server 104 as described above is shown in FIG. 4. Since the details of the processing have been described step-by-step above, the steps will be described in brief hereinbelow.

First, at Step S401, projection data is read into the RAM 53; at Step S402, transmitted data is generated; and at Step 403, the transmitted data is transmitted to the server 104.

The server 104 receives the transmitted data at Step S451, and executes the correction processing on the raw data at Step S452. Next, at Step S453, an X-ray tomographic image is produced by executing image reconstruction processing based on the raw data corrected at Step S452. At Step S454, the data of the X-ray tomographic image is transmitted to the operation console 102. The operation console 102 receives the data of the X-ray tomographic image at Step S404, and saves the received data of the X-ray tomographic image on the HDD 54 or displays it as an image on the CRT 56 at Step S405.

(Second Embodiment)

While the number of server is only one in the first embodiment, a plurality of servers are connected to the network in this embodiment. Particularly, each company has its own server keeping its own application software and connects the server to the network. This allows the operation consoles to use application software of various companies. A system in accordance with this embodiment will be described below.

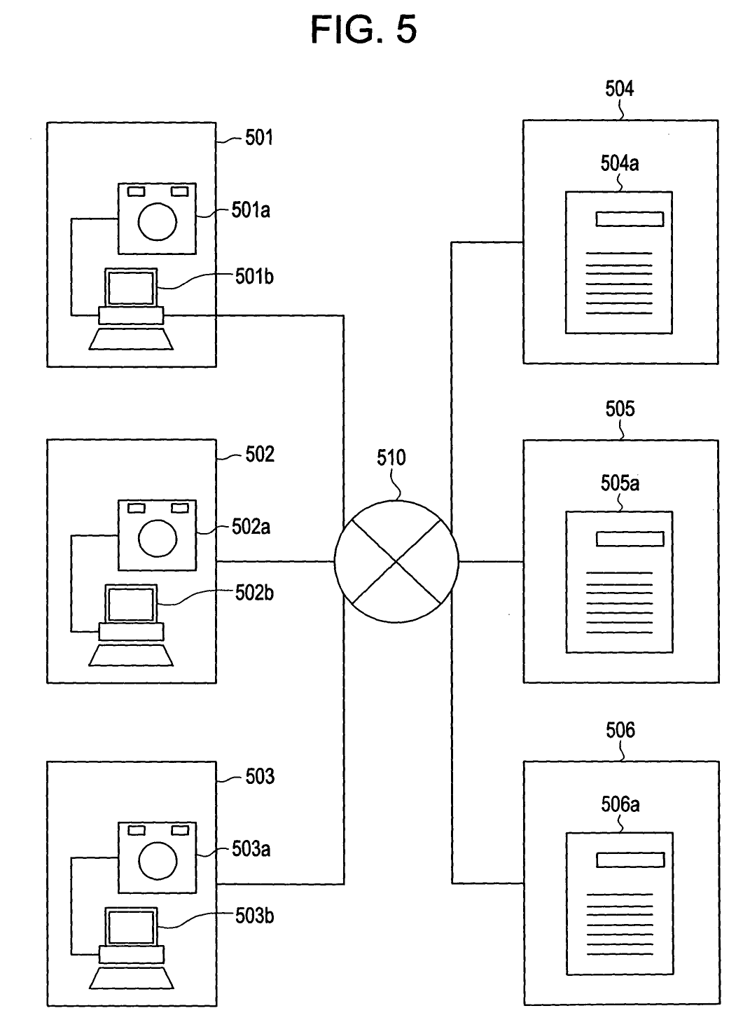

FIG. 5 shows the general configuration of X-ray CT systems in accordance with the present embodiment. Reference numerals 501, 502 and 503 designate hospitals, and each hospital has an X-ray CT apparatus comprised of a gantry apparatus (501a, 502a, 503a) and an operation console (501b, 502b, 503b). In each hospital, projection data of a subject acquired by the gantry apparatus is transmitted to the operation console, and the operation console receives the data, as known in the art.

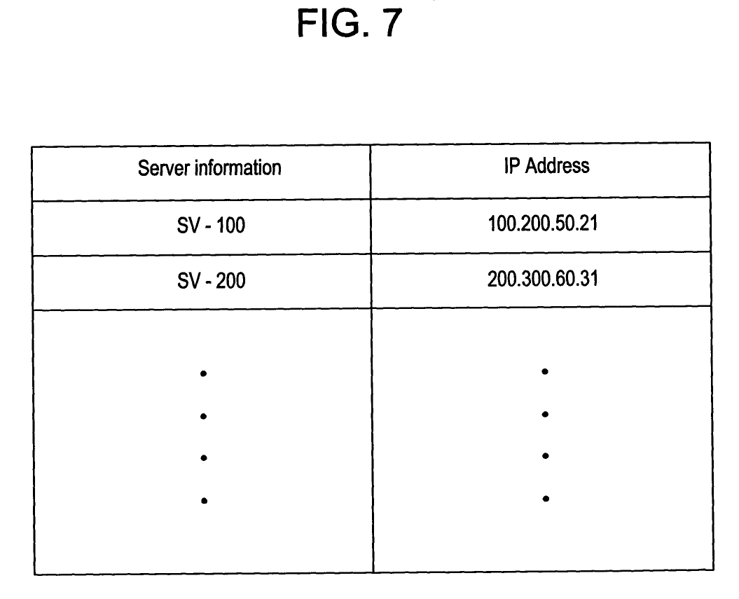

The operation console in each hospital can be connected to a network 510, such as the Internet or a LAN, and the operation console can access via the network 510 servers 504a, 505a, and 506a installed respectively in companies 504, 505 and 506. Moreover, although the basic configuration of each operation console and server is the same as that in the first embodiment, the HDD 54 in the operation console of this embodiment stores a table shown in FIG. 7, which will be described later.

Basically, every company develops its own functions for image reconstruction, and installs the functions in its own server. It will be easily recognized that it is necessary to standardize at least the data format when a company will allow an external party that can have access to the company's server to use the program. In other words, it is a premise in this embodiment that programs installed in these servers should deal with a standardized data format.

Although FIG. 5 shows one X-ray CT apparatus per hospital, the number is not limited thereto but a hospital may possess a plurality of X-ray CT apparatuses; in such a case, each operation console included in each X-ray CT apparatus is configured to be capable of being connected to the network 510 and of accessing the servers 504a, 505a and 506a. Moreover, although the number of hospitals is three in FIG. 5 for convenience, the number is not limited thereto.

Next, when a destination of projection data transmission is to be particularly determined, the GUI software 63 stored on the HDD 54 is loaded on the RAM 53 and executed by the CPU 51, and thus, processing of selection of a destination of projection data transmission is achieved as described below.

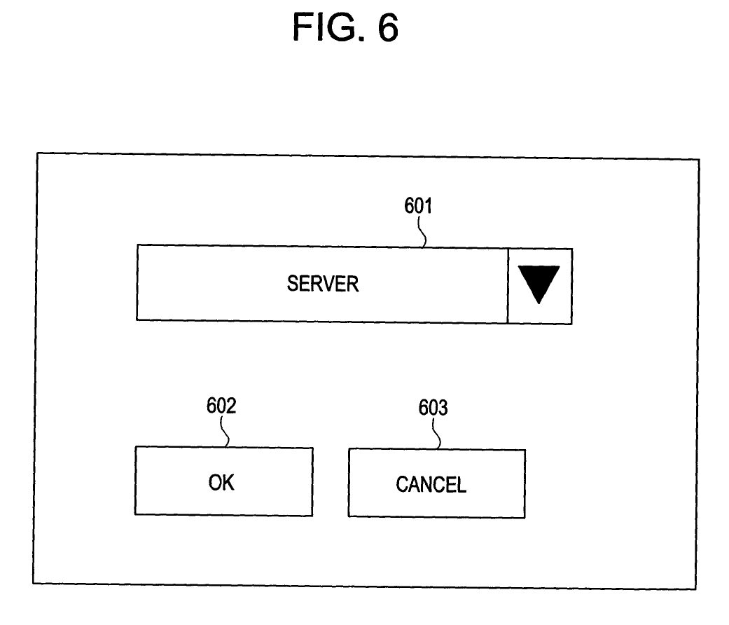

An exemplary GUI for selecting a destination of projection data transmission is shown in FIG. 6. The GUI of FIG. 6 is used for selecting a server to conduct image reconstruction processing based on projection data and to produce an X-ray tomographic image of a subject. The program of the GUI software 63 is loaded on the RAM 53 and executed by the CPU 51, and thus, the GUI shown in FIG. 6 is displayed on the CRT 51.

An area 601 is for displaying information (server information) identifying a destination server to which the projection data is to be transmitted, and its model, model number or the like is displayed. When a operator of the operation console points to the area 601 using the keyboard 57 or mouse 58, information on a plurality of servers registered in a table shown in FIG. 7 stored in the HDD 54 are displayed in a menu style, and server information of a destination server of projection data transmission is selected using the keyboard 57 or mouse 58. In the table of FIG. 7, IP addresses corresponding to the server information are registered, and an address of the selected server on the network 510 can be obtained.

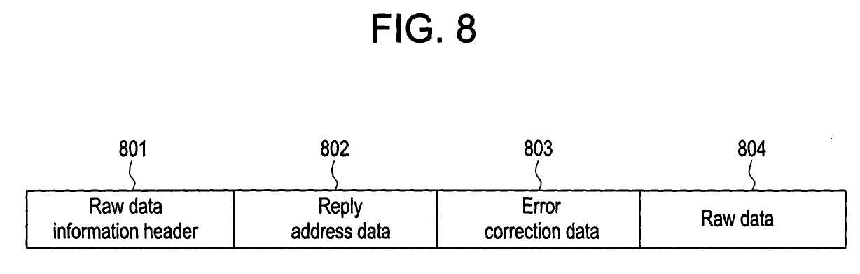

Thus, by selecting server information in the GUI shown in FIG. 6 and pressing a button 602 using the keyboard 57 or mouse 58, the server information is written into the RAM 53 and the data generating software 62 is executed by the CPU 51 to generate transmitted data containing projection data. An exemplary configuration of the transmitted data is shown in FIG. 8.

Reference numeral 801 designates a raw data information header that contains similar information to that of the header 301 shown in FIG. 3. Reference numeral 802 designates reply address data that contains similar data to the data 302 shown in FIG. 3. Reference numeral 803 designates error correction data that contains similar information to that of the data 303 shown in FIG. 3. Reference numeral 804 designates raw data that is similar data to the data 304 shown in FIG. 3 but in a data format adapted to the destination server.

After the data generating software 62 has generated the transmitted data, the communication software 61 loaded on the RAM 53 is executed by the CPU 51, and thereby the transmitted data is transmitted to a server on the network identified by an IP address corresponding to the server information selected at the area 601. Since processing by the server on the transmitted data is the same as that in the first embodiment, description thereof is omitted.

In the present embodiment, billing can be also made to the operator of the operation console who has transmitted projection data to a server and has caused the server to execute production of an X-ray tomographic image. Specifically, the server knows the amount of data processed (the amount of data of the projection data) by referring to the raw data information header 801, and calculates a billing charge accordingly. For example, if the charge is 1,000 yen for 1 MB (megabyte), the billing charge for Z MB is (1,000×Z) yen. The data of the billing charge is transmitted to the operation console along with the data of the X-ray tomographic image.

The method of calculating a billing charge is not limited to that described above, and the billing charge may be calculated corresponding to the time required for the image reconstruction processing, for example.

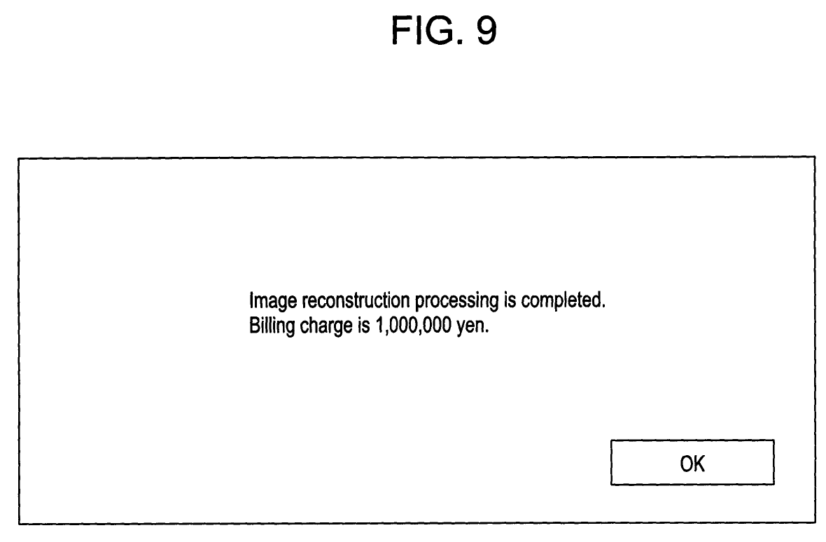

The operation console writes the received data of the X-ray tomographic image and billing charge into the RAM 53 by the CPU 51 executing the communication software 61. Moreover, a window exemplarily shown in FIG. 9 is displayed on the CRT 56 by the CPU 51 executing the GUI software 63 loaded on the RAM 53. The window of FIG. 9 is generated based on the received data representing the billing charge. Moreover, the X-ray tomographic image is written into the VRAM 55 and displayed on the CRT 56 as needed.

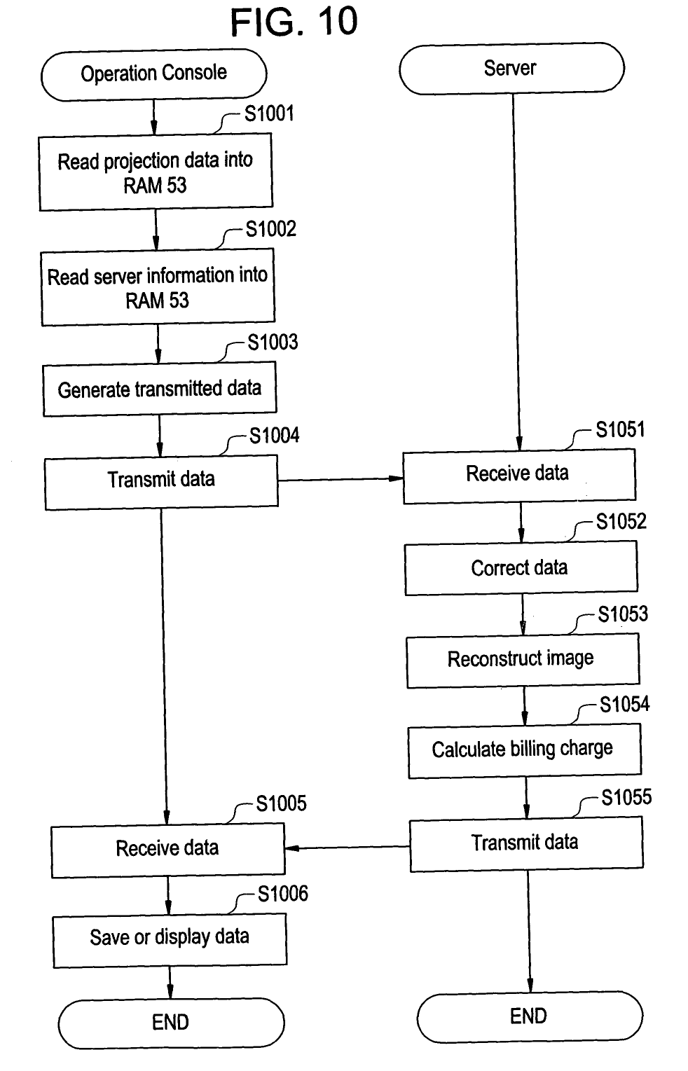

A flow chart of the processing executed by the operation console and server as described above is shown in FIG. 10. Since the details of the processing have been described step-by-step above, the steps will be described in brief hereinbelow.

First, at Step S1001, projection data is read into the RAM 53; and at Step S1002, server information selected by the user using the GUI shown in FIG. 7 is read into the RAM 53. Next, at Step S1003, transmitted data is generated, and the data is transmitted to the server at Step S1004.

The server receives the transmitted data at Step S1005, and executes error correction on the raw data at Step S1052. Next, at Step S1053, image reconstruction processing is executed based on the raw data corrected at Step S1052 to produce an X-ray tomographic image; and moreover, a billing charge is calculated at Step S1054. Then, at Step S1055, the data of the X-ray tomographic image and the data of the billing charge are transmitted to the operation console. At step S1005, the data of the X-ray tomographic image and the data of the billing charge are received at the operation console, and at Step S1006, the window shown in FIG. 9 is displayed on the CRT 56, and the X-ray tomographic image is also displayed as necessary. Moreover, the received X-ray tomographic image may be saved on the HDD 54 at Step S1006.

(Third Embodiment)

While pieces of application software contained in the operation console and server are shown as being separate in the embodiments above, the present invention is not limited thereto and the application software may be unified respectively for the operation console and the server. For example, the communication software 61, data generating software 62 and GUI software 63 may be unified as a piece of application software, and the image reconstruction software 266 and communication software 268 may be unified as a piece of software.

(Fourth Embodiment)

While the X-ray system is used as the medical image capturing system in the embodiments above, the preceding description is not limited thereto but can be applied to an MR system or US system, for example.

Moreover, it is necessary to install dedicated hardware when cone beam BP, for example, is to be conducted, and a health care facility that does not have the hardware cannot obtain a cone beam BP image. Therefore, the health care facility cannot evaluate hardware for executing the cone beam BP when purchasing it.

If this hardware is installed in the server, and a software program for producing the cone beam BP image is further stored in the server, the health care facility can transmit projection data from the operation console at the health care facility to the server, and the server can produce a cone beam BP image and transmit it to the operation console; and thus, the health care facility can obtain materials for considering purchase of the hardware and software.

Moreover, many manufacturers cannot provide sufficient artifact removal software such as AAR. Therefore, if a software program is stored in the server of a company that has the software, operation consoles that have access to the server can use the software, and at the same time, the company can advertise the software. In this case, the format of data to be transmitted to the server must be adapted to one that the server can deal with.

(Fifth Embodiment)

To obtain an X-ray tomographic image based on projection data, the destination of projection data transmission must be decided at the operation console. However, at the decision, the operator of the operation console needs to know beforehand the image quality of an X-ray tomographic image obtained from the destination server, image reconstruction options, and the charge payable to the company of the destination server for executing a series of processing operations.

Therefore, the servers of the companies provide for free a service involving producing an X-ray tomographic image of projection data transmitted, calculating a charge to be virtually billed (a charge for producing an X-ray tomographic image and transmitting it to an operation console), producing an image representing the calculated billing charge (“billing charge image”), and sending the X-ray tomographic image attached with the produced billing charge image back to the operation console.

By such a service, the operator of the operation console in each hospital can transmit projection data to the companies and obtain an X-ray tomographic image and an image representing a charge to be virtually billed to obtain the X-ray tomographic image sent back from the servers of the companies, to thereby learn what quality of X-ray tomographic image can be obtained by what processing options from the server of each company and how much the billing charge for the processing would be; and the operator can decide a server to which he will transmit his data thereafter based on this knowledge.

It should be noted that processing for transmitting an image of the X-ray tomographic image attached with the billing charge image is executed at Step S1054 to provide the service as described above.

(Sixth Embodiment)

The object of the present invention can also be attained by supplying a system or an apparatus with a storage medium (or recording medium) recorded with the program code of software for implementing the functions of the embodiments described above, and causing a computer (or CPU or MPU) in the system or apparatus to read the program stored in the storage medium and execute the program code. In this case, the program read out from the storage medium achieves by itself the functions of the embodiments described above, and therefore, the storage medium storing the program code constitutes the present invention. Moreover, the present invention encompasses, in addition to a case in which the computer (operation console) reads and executes the program code to implement the functions of the embodiments described above, a case in which an operating system (OS) or the like running on the computer executes part or all of actual processing based on instructions of the program code to implement the functions of the embodiments described above by the processing.

When the present invention is applied to the storage medium, the storage medium stores a program code corresponding to part or all of the flow charts described above (shown in FIGS. 8 and 10).

Storage media usable for storing such a program code include, for example, a floppy, disk, hard disk, optical disk, magneto-optical disk, CD-ROM, magnetic tape, non-volatile memory card and ROM. Furthermore, such a program code may be downloaded via a medium such as a network (e.g., the Internet).

Many widely different embodiments of the invention may be configured without departing from the spirit and the scope of the present invention. It should be understood that the present invention is not limited to the specific embodiments described in the specification, except as defined in the appended claims.

1. A medical image capturing system comprising:
a gantry apparatus for collecting imaging data of a subject;
an operation console for sending an operation command to said gantry apparatus; and
at least one server apparatus communicably connected to said operation console via a network; wherein
said operation console comprises:
a receiving device for receiving the collected imaging data from said gantry apparatus; and
a transmitting device for transmitting said received imaging data to said server apparatus; and
said server apparatus comprises:
an image producing device for producing a medical image based on said imaging data transmitted from said operation console; and
a transmitting device for transmitting said produced medical image to said operation console.

2. The medical image capturing system of claim 1, wherein
each said server apparatus comprises a separate image producing device for producing a medical image by a different algorithm based on said imaging data transferred from said operation console, and
said operation console further comprises a selecting device for selecting a server apparatus to which said imaging data received by said receiving device is to be transferred.

3. The medical image capturing system of claim 1, wherein said server apparatus further comprises a conveying device for conveying billing information concerning use of said image producing device to said operation console.

4. The medical image capturing system of claim 1, wherein said server apparatus further comprises a conveying device for conveying a medical image attached with an image representing the billing information concerning use of said image producing device to said operation console.

5. The medical image capturing system of claim 3, wherein said billing information relates to a billing charge corresponding to the amount of data processed by said image producing device.

6. The medical image capturing system of claim 3, wherein said billing information relates to a billing charge corresponding to the time required for the processing for producing said medical image by said image producing device.

7. A server apparatus communicably connected via a network to an operation console for sending an operation command to a gantry apparatus for collecting imaging data of a subject, said server apparatus comprising:
an image producing device for producing a medical image based on said imaging data transmitted from said operation console; and
a transmitting device for transmitting said produced medical image to said operation console.

8. The server apparatus of claim 7, further comprising: a conveying device for conveying billing information concerning use of said image producing device to said operation console.

9. A method of controlling a medical image capturing system comprising a gantry apparatus for collecting imaging data of a subject, an operation console for sending an operation command to said gantry apparatus, and at least one server apparatus communicably connected to said operation console via a network, said method comprising:
a method of controlling said operation console comprising:
a receiving step of receiving the collected imaging data from said gantry apparatus; and
a transmitting step of transmitting said received imaging data to said server apparatus; and
a method of controlling said server apparatus comprising:
an image producing step of producing a medical image based on said imaging data transmitted from said operation console; and
a transmitting step of transmitting said produced medical image to said operation console.

10. The method of controlling a medical image capturing system of claim 9, wherein
said method of controlling each said server apparatus comprises a separate image producing step of producing a medical image by a different algorithm based on said imaging data transferred from said operation console, and
said method of controlling said operation console further comprises a selecting step of selecting a server apparatus to which said imaging data received at said receiving step is to be transferred.

11. The method of controlling a medical image capturing system of claim 9, wherein said method of controlling said server apparatus further comprises a conveying step of conveying billing information concerning use of said image producing step to said operation console.

12. The method of controlling a medical image capturing system of claim 9, wherein said method of controlling said server apparatus further comprises a conveying step of conveying a medical image attached with an image representing the billing information concerning use of said image producing step to said operation console.

13. The method of controlling a medical image capturing system of claim 11, wherein said billing information relates to a billing charge corresponding to the amount of data processed by said image producing device.

14. The method of controlling a medical image capturing system of claim 11, wherein said billing information relates to a billing charge corresponding to the time required for the processing for producing said medical image at said image producing step.
